(19) United States
(12) Patent Application Publication
(10) Pub. No.: US 2025/0214313 A1
(43) Pub. Date: Jul. 3, 2025

(54) APPARATUS FOR MOULDING AN OBJECT WITH A MATERIAL DERIVED FROM NATURAL FIBRES

(71) Applicant: SACMI COOPERATIVA MECCANICI IMOLA SOCIETA' COOPERATIVA, Imola (Bologna) (IT)

(72) Inventors: Fabrizio PUCCI, Imola (Bologna) (IT); Davide ZANOTTI, Imola (Bologna) (IT); Francesco PIRAZZOLI, Imola (Bologna) (IT); Giovanni MAZZOTTI, Imola (Bologna) (IT); Fiorenzo PARRINELLO, Imola (Bologna) (IT)

(21) Appl. No.: 18/875,388

(22) PCT Filed: Jun. 28, 2023
(86) PCT No.: PCT/IB2023/056662

§ 371 Date: Dec. 16, 2024

(30) Foreign Application Priority Data
Jul. 4, 2022 (IT) 102022000014140

(51) Int. Cl. B31B 50/59; B31B 110/00

(52) U.S. Cl. CPC B31B 50/592; B31B 50/594; B31B 2110/00

(57) ABSTRACT

A moulding apparatus for forming an object from a dose of material derived partially from natural fibres, having a forming region delimited by a lateral surface extending around a central zone of the forming region. The apparatus includes a first half-mould defining the forming region, including a transverse surface and the lateral surface defining a forming cavity, a second half-mould mutually movable with respect to the first half-mould along a moulding axis so as to be inserted into the forming cavity for shaping the dose, and a compensation device which can be positioned at a variable distance from the transverse surface through a mutual movement of the compensation device and the forming cavity, so as to determine a final size of the object to be formed as a function of the volume of the dose inserted into the forming cavity.

The present invention relates to a moulding apparatus for producing objects by compressing a mouldable material.

The mouldable material may comprise a material derived from natural fibres, for example cellulose. In other words, the mouldable material may be a cellulose-based material.

The material derived from natural fibres may be powder, solid or pasty. For example, the material derived from natural fibres may comprise a powder to be pressed, or may be in the form of a swab, or even in the form of a film, or a pre-processed material for example of a flat, concave or disc shape.

The moulding apparatus according to the invention is particularly (but not exclusively) adapted to produce objects having a concave shape, for example containers or caps for containers. The objects produced by the moulding apparatus according to the invention may have a lateral wall having a curved geometry, particularly a geometry which, seen in plan, is circular, oval or elliptical.

However, the moulding apparatus according to the invention may also be used to form objects having other geometries, for example substantially flat objects.

In the field of moulding, it is sometimes desirable to define a forming region whose volume may be progressively reduced, for a variety of reasons.

This requirement arises when moulding objects from materials derived from natural fibres, for example cellulose, which have a very low initial density and need to be pressed with a high degree of compaction to provide a good quality packaging component. This means that when a material derived from natural fibres is subjected to a moulding process, the initial volume of the material derived from natural fibres is much greater than the volume of the finished object. This must be taken into account in the design of moulds to form objects by moulding a material derived from natural fibres.

The known compression moulding apparatuses comprise an extruder from which a continuous extrudate of synthetic polymeric material outflows and one or more cutting elements for cutting the continuous extrudate in order to separate consecutive doses of polymeric material from the latter. The known apparatuses further comprise one or more moulds for receiving corresponding doses of polymeric material and making an object from each dose. Each dose is inserted into the corresponding mould while the latter is in an open position.

The doses used in the known apparatuses usually have a simple shape, for example spherical or cylindrical, for reasons related to the production methods thereof. The shape of the doses is often very different from the objects to be produced.

In particular, the quantity or size of the dose inserted into the mould can lead to very different results in the forming of the final object. For example, during moulding, the excess portion of dose can exit from the mould leaving a scrap which defines an excessive edge of the object.

Such a scrap must necessarily be removed, therefore implying trimming operations that can be expensive and lead to longer manufacturing times for the moulded object.

The technical task of the present invention is to provide a moulding apparatus which can overcome the prior-art drawbacks which have emerged.

An object of the present invention is therefore that of providing a moulding apparatus which enables an object or a cap to be moulded which do not require any subsequent operations, such as for example a trimming operation.

A further object of the present invention is therefore that of providing a moulding apparatus able to compensate for dose centring variations.

Therefore, a further object of the present invention is that of providing a moulding apparatus which enables waste to be reduced and/or the costs due to subsequent operations to moulding to be reduced (if not actually eliminated).

The specified technical task and the specified aims are substantially achieved by a moulding apparatus comprising the technical characteristics set forth in one or more of the appended claims. The dependent claims correspond to possible embodiments of the invention.

In particular, the specified technical task and specified aims are substantially obtained by a moulding apparatus for forming an object from a dose of material derived at least partially from natural fibres, having a forming region delimited by a lateral surface which extends around a central zone.

The moulding apparatus comprises a first half-mould, defining the forming region, comprising a transverse surface and the lateral surface defining a forming cavity and a second half-mould movable mutually with respect to the first half-mould along a moulding axis so as to be inserted into the forming cavity for shaping the dose in the object.

The apparatus further comprises a compensation device which can be positioned at a variable distance from said transverse surface through a mutual movement of the compensation device and the forming cavity, so as to determine a final size of the object to be formed as a function of the volume of the dose inserted into the forming cavity.

According to an aspect of the present invention, the compensation device comprises an end defining a pushing portion conformed so as to be inserted at least partially into the perimeter portion of the forming cavity to retain portions of the object inside the forming cavity.

According to a further aspect of the present invention, the compensation device comprises an end defining a retaining portion conformed so as to abut at least partially against the first half-mould so as to occlude the perimeter portion of the forming cavity and/or retain a scrap portion of the object against the first half-mould.

According to an aspect of the present invention, the apparatus further comprises a cutting device adapted to abut against the first half-mould for cutting a scrap of the object exiting from the forming chamber.

According to an aspect of the present invention, the first half-mould comprises a plurality of sectors which define the lateral surface. Each sector comprises a body delimited by a forming surface. The first half-mould further comprises at least a first pushing device for applying on a first sector of the plurality a first force directed towards the central zone in a first direction and at least a second pushing device for applying on a second sector of the plurality a second force directed towards the central zone in a second direction arranged transversally to the first direction.

The second sector is in contact with the first sector for transmitting the second force to the first sector, so that the forming surface of the first sector is moved towards the central zone under the combined action of the first force and the second force, in order to reduce the volume of the forming region.

The specified technical task and specified aims are also achieved by a moulding apparatus for forming an object from a dose of material derived at least partially from natural fibres, having a forming region delimited by a lateral surface which extends around a central zone.

The moulding apparatus comprises a first half-mould, defining the forming region, comprising a transverse surface and the lateral surface defining a forming cavity and a second half-mould movable mutually with respect to the first half-mould along a moulding axis so as to be inserted into the forming cavity for shaping the dose in the object.

The apparatus further comprises a cutting device adapted to abut against the first half-mould for cutting a scrap of the object exiting from the forming chamber.

According to a further aspect of the present invention, the apparatus provided with the cutting device further comprises a compensation device. Further characteristics and advantages of the present invention will become more apparent from the indicative and thus non-limiting description of an embodiment of a moulding apparatus.

Such a description will be set out below with reference to the appended drawings, which are provided solely for illustrative and therefore non-limiting purposes, in which:

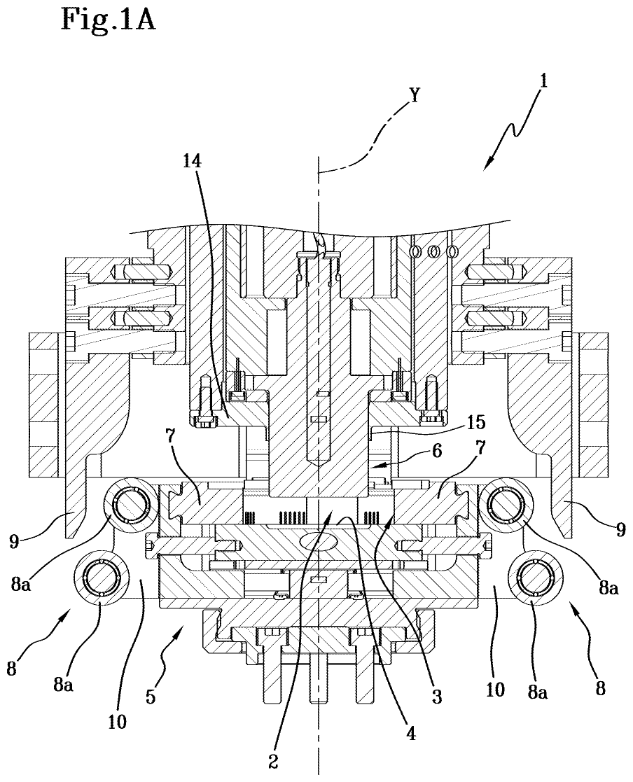

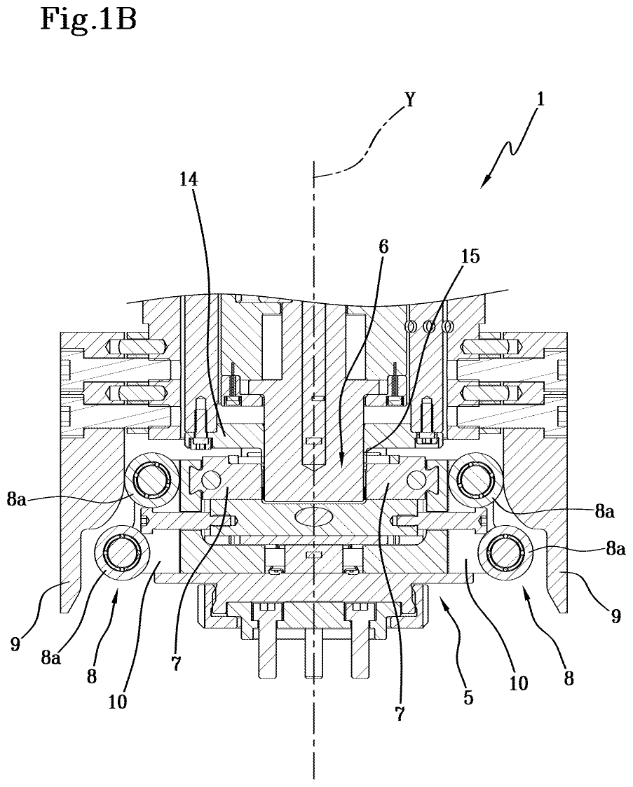

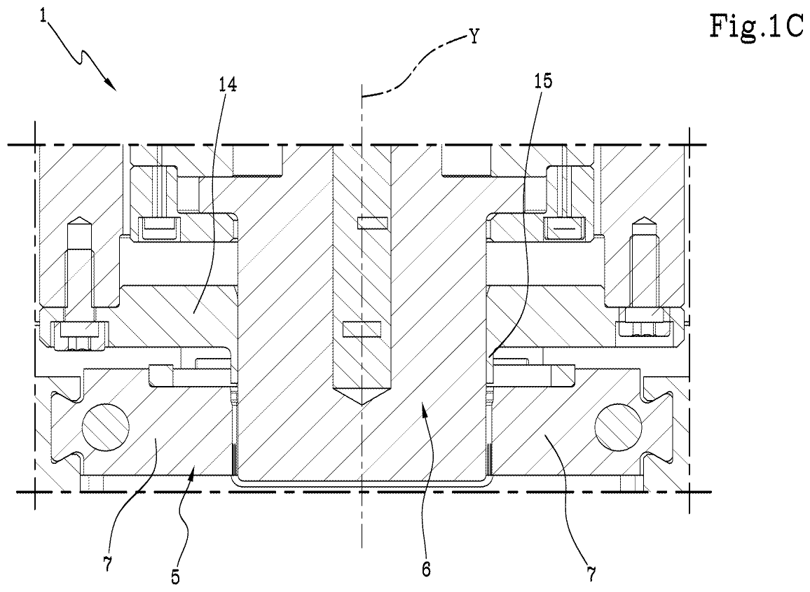

FIGS. 1A-1C are a schematic representation of different working steps of an embodiment of the apparatus according to the present invention;

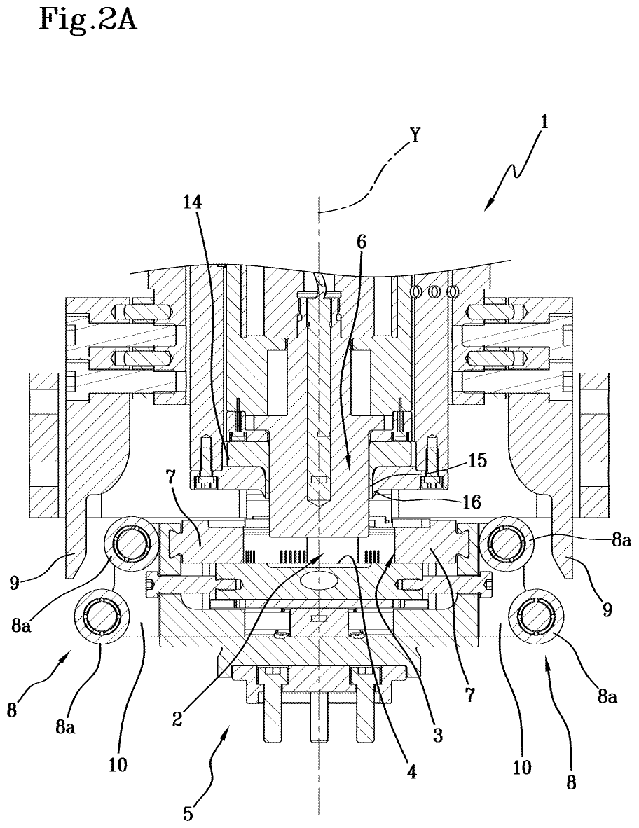

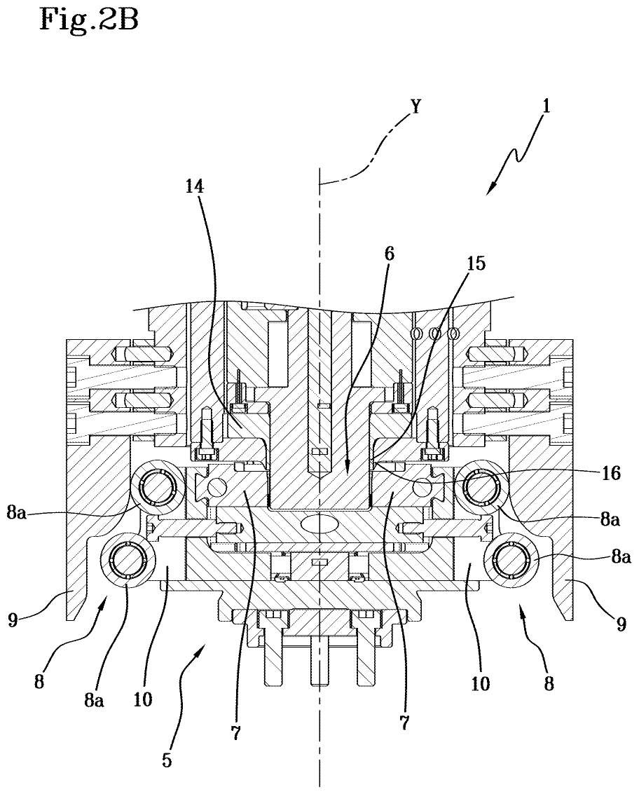

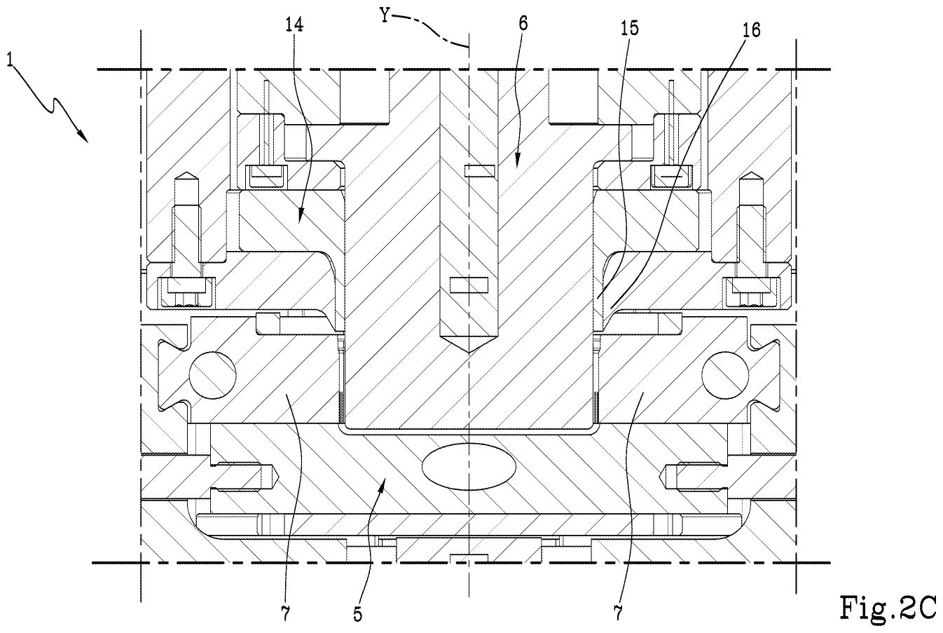

FIGS. 2A-2C are a schematic representation of different working steps of a further embodiment of the apparatus according to the present invention;

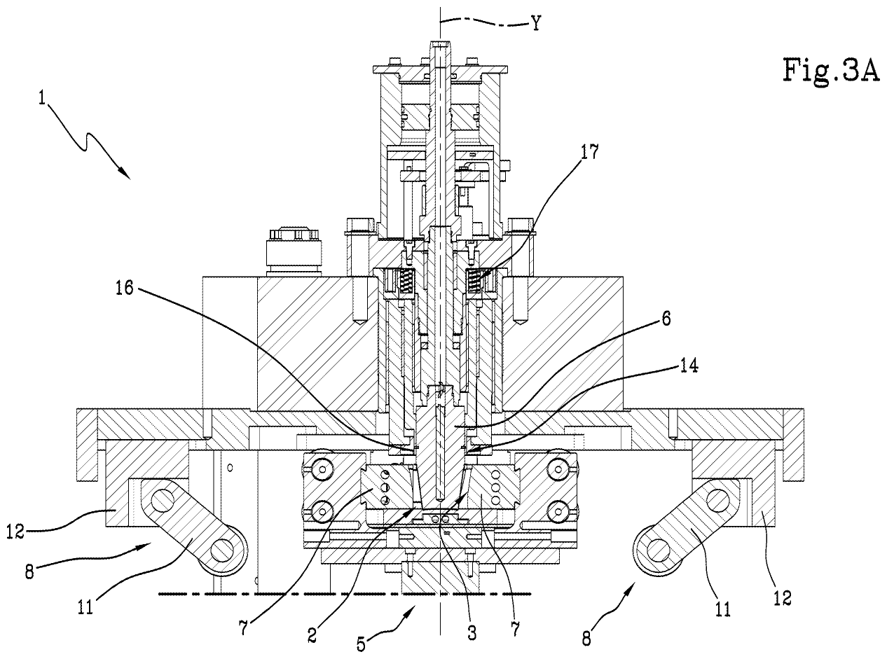

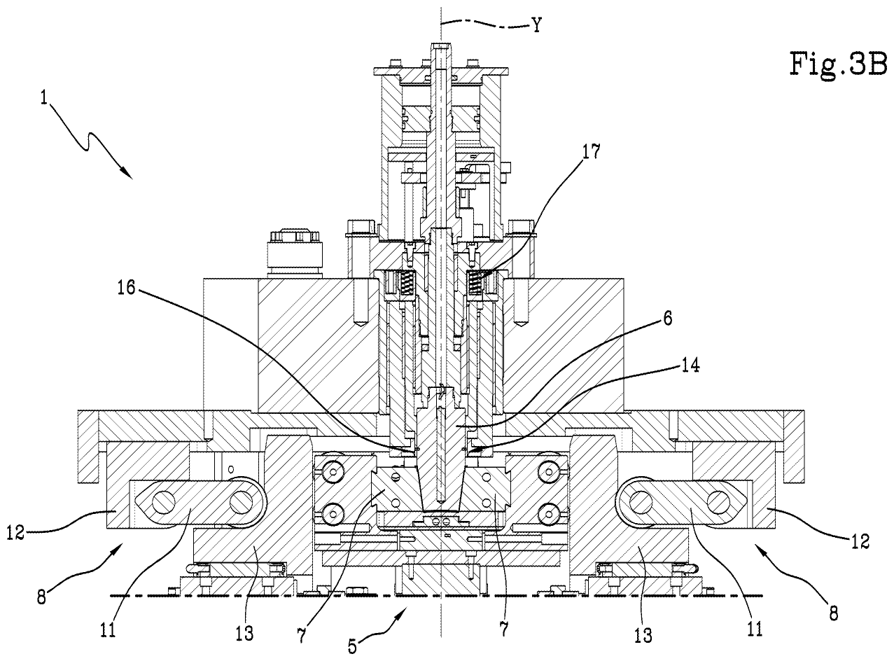

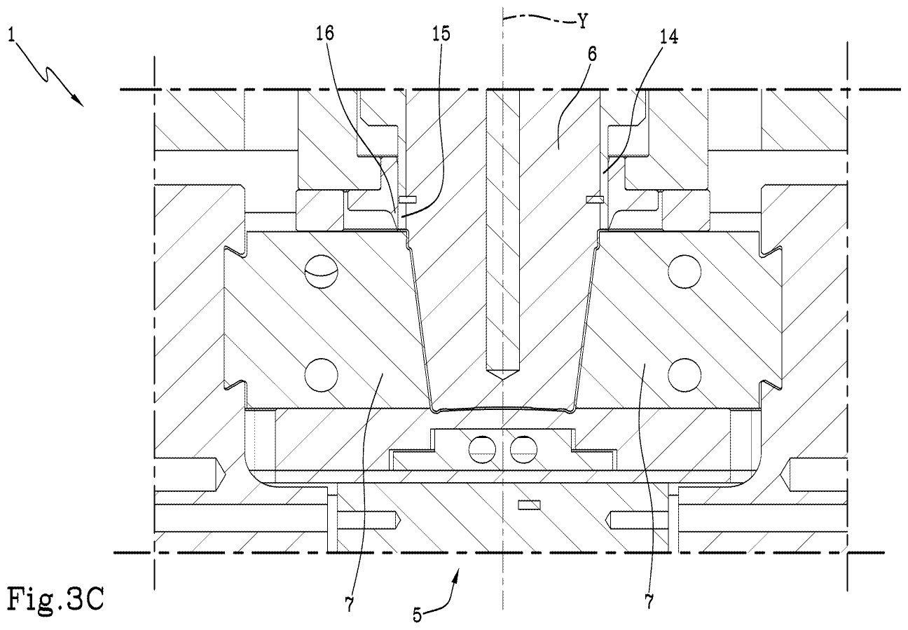

FIGS. 3A-3C are a schematic representation of different working steps of a further embodiment of the apparatus according to the present invention.

With reference to the appended figures, 1 indicates in its entirety a moulding apparatus for forming an object from a dose of material derived from natural fibres which, for simplicity of description, will be referred to below as apparatus 1.

The apparatus 1 is thus a device for producing objects by compression of a mouldable material at least partially derived from natural fibres. The mouldable material may comprise a material derived from wood fibres such as cellulose.

The moulding apparatus 1 is particularly suitable for producing concave objects, such as containers or caps for containers.

The concave objects produced by the moulding apparatus 1 may comprise a lateral wall and a transverse wall which closes the lateral wall at one end thereof. The lateral wall may have, in plan, a circular, or elliptical, or oval or other perimeter.

The moulding apparatus 1 may also be used to produce other types of objects, for example necks of containers.

The material at least partially derived from natural fibres processed by the moulding apparatus 1 may for example be in the form of powder or granules. The powder or granules may be intended to be pressed dry, or with the addition of water or other liquids to obtain a paste which will subsequently be formed in the moulding apparatus 1. Additives or other substances of synthetic origin, for example synthetic polymers, may be added to the material derived from natural fibres.

The material at least partially derived from natural fibres processed by the moulding apparatus 1 may also be in spongy, or swab form. It is also possible that the moulding apparatus 1 receives a material at least partially derived from natural fibres configured as a film, for example of circular or quadrangular shape. Alternatively, the moulding apparatus 1 may process a material at least partially derived from natural fibres configured as a pre-processed element, for example a pre-compacted element with a certain degree of compaction of the natural fibres, lower than the degree of compaction which the fibres will have in the finished object. The pre-processed element could be, for example, flat or concave, i.e., having the shape of a cup.

The moulding apparatus 1 has a forming region 2 in which the mouldable material is shaped to obtain the object. The forming region 2 has a volume which, as will be better described below, can be progressively reduced from the moment in which the forming region 2 receives the mouldable material, until the moment in which the object is obtained. The forming region 2 is therefore a variable-volume forming region.

The forming region 2 is delimited by a lateral surface 3, which surrounds a central zone. The lateral surface 3 is intended to externally shape the lateral wall of the object. In other words, the lateral surface 3 extends around the central zone.

The forming region 2 may also be delimited by a transverse surface 4, arranged transversely to the moulding direction to externally shape the transverse wall of the object.

The transverse surface 4 may be substantially flat, or slightly concave, or may have other shapes.

In particular, the apparatus 1 comprises a first half-mould 5, defining the forming region 2, comprising the transverse surface 4 and the lateral surface 3 defining a forming cavity.

In other words, the first half-mould 5 is to be considered as a female part of mould.

Furthermore, the apparatus 1 comprises a second half-mould 6 movable relatively against the first half-mould 5 so as to be inserted into the forming cavity for shaping the dose providing it with the shape of the object.

In other words, the second half-mould 6 is to be considered as a male part of mould.

Preferably, the first half-mould 5 is movable towards the second half-mould 6.

The first half-mould 5 and the second half-mould 6 are movable with respect to each other along a moulding direction parallel to a moulding axis “Y” which in the illustrated example is vertical.

This condition is not necessary and, in an alternative version, the moulding axis “Y” may be horizontal, or inclined.

The transverse surface 4 is therefore transverse, preferably perpendicular, to the moulding axis “Y”.

Preferably, the second half-mould 6 is made in the form of a punch. Preferably, as for example shown in the appended figures, the first half-mould 5 comprises a plurality of sectors 7 which define the lateral surface 3. Each sector 7 has a body delimited by a forming surface. Each forming surface defines the lateral surface 3. Each sector 7 is in contact with an adjacent sector 7.

The first half-mould 5 further comprises at least one first pushing device for applying on a first sector 7 a first force directed towards the central zone of the forming region 2. In this way, the first pushing device enables the distance between the sliding surface of the first sector 7 and the moulding axis “Y” to be reduced.

Furthermore, the first half-mould 5 further comprises at least one second pushing device for applying on a first sector 7 a second force directed towards the central zone of the forming region 2 in a second direction arranged transversally to the first direction.

The second sector 7 is in contact with the first sector 7 for transmitting the second force to the first sector 7. In this way, the forming surface of the first sector 7 is moved towards the central zone under the combined action of the first force and the second force, to reduce the volume of the forming region 2.

The first sector 7 is therefore in contact with the second sector 7 along a contact surface of the first sector 7. The contact surface of the first sector 7 is slidable along a sliding surface of the second sector 7 under the action of the first force. The contact surface of the first sector 7 extends transversally to the second direction.

The forming surface of the first sector 7 is movable towards the central zone along a linear trajectory directed obliquely with respect to the first direction and the second direction. Likewise, the forming surface of the second sector 7 is movable towards the central zone along a linear trajectory directed obliquely with respect to the first direction and the second direction.

What has been described above is applicable to each sector 7 of the plurality of sectors 7 that compose the first half-mould 5 and the joint action of each sector enables the reduction (or expansion) of the forming region 2 to be obtained. Furthermore, the application of different forces enables different shapes of the forming region 2 to be obtained.

Preferably, a forming appendage delimited by the forming surface projects from the body of each sector 7. The forming surface is curved, for example having the shape of a portion of cylinder.

In general, a force directed towards the moulding axis “Y” is applied to each of the sectors 7, which pushes the forming appendage of the corresponding sector 7 towards the central zone of the forming region 2.

The first pushing device and the second pushing device are included in a plurality of pushing devices 8. A pushing device of the plurality of pushing devices 8 is associated with each sector 7 of the plurality of sectors 7.

In the attached figures, the pushing devices 8 are of the mechanical type.

With reference to the embodiments of FIGS. 1A-1C and 2A-2C, each pushing device 8 of the plurality of pushing devices 8 comprises at least one roller 8a which is engaged with a control element 9 supported by the second half-mould 6 or by a portion of the apparatus 1 associated with the second half-mould 6.

In an alternative embodiment, not shown, the control element 9 may be supported by the first half-mould 5 or by a portion of the apparatus 1 associated with the first half-mould 5.

In the appended figures, each pushing device 8 comprises a pair of rollers 8a.

Each sector 7 is further associated with a support 10 which supports at least one pin on which a respective roller 8a is mounted. In particular, in the appended figures, the support 10 supports two pins on which the rollers 8a are mounted.

The rollers 8a are free to rotate about respective axes of rotation arranged transversely, in particular perpendicularly, to the moulding direction.

The axes of rotation of the rollers 8a may be parallel to each other with a first roller 8a arranged at a different height from a second roller 8a.

The control element 9 enables the position of the rollers 8a associated with a sector 7 to be controlled and the rollers 8a to be moved according to a predetermined law of motion. By using two rollers 8a per sector 7, it is thus possible to more precisely control the position of the corresponding sector 7 and the final shape of the forming region 2.

With reference to the embodiments of FIGS. 3A-3C, each pushing device 8 of the plurality of pushing devices 8 comprises a linkage 11 interposed between a sector 7 and a support member 12. In other works, the linkage 11 includes a lever having one end hinged to the support member 12 and one end hinged to a pushing element 13 able to push the respective sectors 7.

The apparatus 1 further comprises a compensation device 14 which can be positioned at a variable distance from the transverse surface 4 through a mutual movement of the compensation device 14 and of the forming cavity.

In this way, the compensation device 14 determines a final dimension of the object to be formed as a function of the volume of the dose inserted into the forming cavity.

Preferably, the compensation device 14 is arranged to interact with the dose in a perimeter portion of the forming cavity. For simplicity of description, in the following description mention will be made of the interaction of the compensation device 14 with the perimeter portion of the forming cavity.

In other words, the compensation device 14 is adapted to move towards a perimeter portion of the forming cavity at a variable height, which can be measured from the transverse surface 4, in order to compensate, as a function of a quantity of dose inserted into the forming cavity, for a final dimension of the object to be formed.

In particular, with reference to the embodiments of the appended figures, a movement of the first half-mould 5 against the second half-mould 6 leads to a reduction in the distance between the compensation device 14 and the transverse surface 4 which, as will become clearer in the following description, leads to the compensation action of the object to be formed.

Preferably, the compensation device 14 is movable in relation to the first half-mould 5 with a floating movement towards the perimeter portion of the forming cavity.

Preferably, the compensation device 14 is movable in relation to the first half-mould 5 so as to create a vertical compensation.

According to an embodiment of the apparatus 1, the apparatus 1 itself comprises a spring system connected or connectable to the compensation device 14 so as to move the compensation device 14 itself with a floating motion.

A spring system means a system composed of one or more springs configured to exert a force on the compensation device 14 so that the latter “opposes” an advancement of the first half-mould 5 with respect to the second half-mould 6.

Preferably, the compensation device 14 is fitted onto the second half-mould 6.

If the second half-mould 6 is made in the form of a punch, the compensation device 14 has an annular shape and is concentric to the punch.

Preferably, the compensation device 14 is rigidly integral with the second half-mould 6, as shown for example in FIGS. 3A-3C. In this way, during the descent of the second half-mould 6, the compensation device 14 moves towards the first half-mould 5 simultaneously to the second half-mould 6.

Preferably, the compensation device 14 is movable independently from the second half-mould 6. In this way, the compensation device 14 enables a compensation as an effective function of the material present inside the forming cavity.

Alternatively, the compensation device 14 is movable for a first section of its descent simultaneously with the second half-mould 6 and, for a final section thereof, independently.

According to a further aspect of the present invention, the apparatus 1 further comprises a cutting device 16 adapted to abut against the first half-mould 5 for cutting a scrap of the object exiting from the forming chamber.

The cutting device 16 is concentric to the compensation device 14.

Preferably, the compensation device 14 is inserted into the second half-mould 16.

Preferably, the cutting device 16 has an analogous shape to that of the compensation device 14.

Preferably, the cutting device 16 comprises a cutting portion made in the form of a blade or a die.

Preferably, the cutting device 16 is made in the form of a die configured to attribute a specific shape to the portion of the object not separated by the formed walls.

In an embodiment not shown, the first half-mould 5 has a relevant seat and the cutting device 16 is configured to be inserted into the seat. In this embodiment, the cutting device 16 is not necessarily made in the form of a blade or die as the action of inserting it into the seat causes the separation of the scrap from the rest of the object.

In a further embodiment not shown, the first half-mould 5 can be provided with its own cutting portion which, by interacting with the cutting device 16, causes the separation of the scrap.

As shown for example in FIGS. 3A-3C, the apparatus 1 comprises a spring system 17 connected or connectable to the cutting device 16 so as to move the cutting device 16 with floating motion. In other words, thanks to the spring system 17, a movement of the first half-mould 5 with respect to the second half-mould 6 implies that the cutting device 16, after coming into contact with the first half-mould 5, exerts a force which opposes the movement of the first half-mould 5, guaranteeing the necessary force to obtain a clean cut of the excess scrap.

Preferably, the cutting device 16 is movable independently from the compensation device 14.

With reference to the embodiment of the apparatus 1 of FIGS. 1A-1C, the compensation device 14 comprises an end 15 defining a pushing portion conformed so as to be inserted at least partially into the perimeter portion of the forming cavity to retain portions of the object inside said forming cavity. In such embodiment, the compensation device 14 is not integral with the second half-mould 6 and is movable with the aid of the spring system (not shown).

The variable height at which the compensation device 14 is moved towards the perimeter portion of the forming cavity is therefore measured from the transverse surface 4 at a lower portion of the end 15.

In other words, as a function of a quantity of material with which the dose is made, the pushing portion will be inserted at different heights into the forming cavity.

In use, the pushing portion pushes to compress a lateral wall of the object during its formation and, as a function of the force of the spring, will stop pushing when there is no longer any opposition by it.

FIG. 1A shows an apparatus 1 in which the forming region 2 still does not have the desired conformation for obtaining the object. In FIG. 1B, the sectors 7 are moved towards each other and the forming region 2 has the desired conformation defining a forming cavity suitable for obtaining the object. In FIG. 1B, the second half-mould 6 is already inserted into the forming cavity while the pushing portion of the compensation device 14 is in proximity to the perimeter portion of the forming cavity. In FIG. 1C, the pushing portion is inserted into the free portion of the forming cavity (i.e. the perimeter portion) stopping any excess material which could exit therefrom during the forming operation.

With reference to the embodiment of the apparatus 1 of FIGS. 2A-2C, the end 15 defines a retaining portion conformed so as to abut at least partially against the first half-mould 5 (i.e. an upper portion of the sectors 7) so as to occlude the perimeter portion of the forming chamber. In other words, the end 15 faces the perimeter portion of the forming chamber so as to occlude it.

In this embodiment the apparatus further comprises the cutting device 16.

In this way, the apparatus 1 is able both to cut the scrap and form the portion of the object not removed during the cutting operation.

In particular, in this embodiment the compensation device 14 and the cutting device 16 are movable between each other independently. Therefore, both are movable independently through respective spring systems (neither represented).

FIG. 2C shows a pushing portion occluding the forming cavity remaining at a height measured starting from an upper portion of the first half-mould 5 (i.e. from the sectors 7) to a lower portion of the pushing portion. The predefined thickness thus obtained defines a further portion of the forming chamber for creating an edge of the walls of the object to be formed. In particular, the height is defined by the quantity of material exiting after the action of the cutting portion.

In use, once the scrap has been removed with the cutting portion, the excess material continues to exit and the pushing portion opposes its ascent further forming the edge of the wall of the object.

Therefore, the pushing portion (i.e. the end 15) performs the dual task of preventing the exit of the material from the forming cavity, thus preventing the formation of a scrap, and defining a further portion of the male part of mould for forming the edge of the walls of the object.

In an embodiment not illustrated, the end 15 can be conformed both so as to be inserted into the perimeter portion of the forming cavity and to rest on the first half-mould 5 and on the sectors 7.

With reference to the embodiment of the apparatus 1 of FIGS. 3A-3C, the compensation device 14, integral with the second half-mould 6, comprises an end 15 defining a retaining portion conformed so as to abut at least partially against the first half-mould 5 so as to retain a scrap portion of the object against the first half-mould 5.

In such embodiment, the apparatus 1 comprises the cutting device 16 configured to abut against the first half-mould 5 (i.e. against the sectors 7).

In this way, the cutting portion enables the cutting or removal of the scrap formed during the forming operation.

In particular, in this embodiment, the apparatus 1 comprises a further spring system 17 connected or connectable to the cutting device 16 for creating the floating motion thereof.

In particular, as shown in FIG. 3C, once the scrap has been formed, the end 15 is moved closer to retain the scrap and the blade of the cutting portion is moved closer to the first half-mould 5 (i.e. to the sectors 7) so as to separate the scrap from the formed object.

Preferably, the apparatus 1 can be made by combining the different aspects described above.

For example, also the apparatus 1 of FIGS. 1A-1C could be provided with the cutting device 16 so as to cut a scrap that could form if the dose of material is excessive. In this case, the end 15, even if it is conformed to do so, would not be inserted into the forming cavity and an analogous task to that described for the embodiment of FIGS. 2A-2C would be performed.

According to a further aspect of the present invention, an apparatus 1 is provided comprising a first half-mould 5 and a second half-mould 6 as previously described. In such embodiment, the apparatus 1 comprises a cutting device 16 adapted to abut against said first half-mould 5 for cutting a scrap of said object exiting from said forming chamber.

In this way, after the movement along the moulding direction of the first half-mould 5 and the second half-mould 6, the cutting device 16 abuts against the first half-mould 5 so as to cut any scrap that has formed due to the forming action and exiting from the forming chamber.

Preferably, also in this embodiment there may be a compensation device 14, according to one or more of the embodiments previously described.

Advantageously, the apparatus 1 is capable of overcoming the drawbacks which have emerged from the prior art.

Advantageously, the apparatus 1 is capable of making a vertical compensation (i.e. parallel to the moulding axis “Y”).

Advantageously, the compensation device 14 prevents the formation of an excess portion of the object and the cutting device 16 enables a scrap to be removed.

Advantageously, the apparatus 1 enables the object to be formed to be finished off without needing any further operations once the object has been removed from the mould.

1. A moulding apparatus (1) for forming an object from a dose of material derived at least partially from natural fibres, having a forming region (2) delimited by a lateral surface (3) extending around a central zone of the forming region (2), the moulding apparatus (1) comprising:
a first half-mould (5) defining said forming region (2), the first half-mould (5) comprising a transverse surface (4) and said lateral surface (3) which define a forming cavity;
a second half-mould (6), the first half-mould (5) and the second half-mould (6) being mutually movable along a moulding axis (Y) so that the second half-mould (6) is inserted into said forming cavity for shaping said dose; and
a compensation device (14) which can be positioned at a variable distance from said transverse surface (4) through a mutual movement of the compensation device (14) and the forming cavity, so as to determine a final size of the object to be formed as a function of the volume of the dose inserted into said forming cavity.

2. The apparatus (1) according to claim 1, wherein the compensation device (14) is arranged to interact with the dose in a perimeter portion of the forming cavity.

3. The apparatus (1) according to claim 1, wherein said compensation device (14) comprises an end (15) defining a pushing portion conformed so as to be inserted at least partially into said forming cavity to retain portions of the object inside said forming cavity.

4. The apparatus (1) according to claim 1, wherein said compensation device (14) comprises an end (15) defining a retaining portion conformed so as to abut at least partially against said first half-mould (5) so as to occlude said forming cavity and/or retain a scrap portion of the object against said first half-mould (5).

5. The apparatus (1) according to claim 1, wherein said compensation device (14) is fitted onto said second half-mould (6).

6. The apparatus (1) according to claim 1, wherein said second half-mould (6) is made in the form of a punch and wherein said compensation device (14) has an annular shape and is concentric to said punch.

7. The apparatus (1) according to claim 1, wherein said compensation device (14) is rigidly integral with said second half-mould (6).

8. The apparatus (1) according to claim 1, wherein said compensation device (14) is movable in relation to the first half-mould (5) with a floating motion.

9. The apparatus (1) according to claim 8, comprising a spring system connected or connectable to said compensation device (14) so as to move said compensation device (14) with the floating motion.

10. The apparatus (1) according to claim 1, further comprising a cutting device (16) adapted to abut against said first half-mould (5) for cutting a scrap of said object exiting from said forming chamber.

11. The apparatus (1) according to claim 10, wherein said cutting device (16) comprises a cutting portion made in the form of a blade or a die.

12. The apparatus (1) according to claim 10, comprising a spring system (17) connected or connectable to said cutting device (16) so as to move said cutting device (16) with floating motion.

13. The apparatus (1) according to claim 10, wherein said cutting device (16) is movable independently from said compensation device (14).

14. The apparatus (1) according to claim 1, wherein said first half-mould (5) comprises:
a plurality of sectors (7) which define the lateral surface (3), each sector (7) having a body delimited by a forming surface,
at least a first pushing device for applying, on a first sector (7) of said plurality, a first force directed towards the central zone in a first direction,
at least a second pushing device for applying, on a second sector (7) of said plurality, a second force directed towards the central zone in a second direction, the second direction being arranged transversely to the first direction,
wherein the second sector (7) is in contact with the first sector (7) for transmitting the second force to the first sector, so that the forming surface of the first sector is moved towards the central zone under the combined action of the first force and the second force, in order to reduce the volume of the forming region (2).

15. A moulding apparatus (1) for forming an object from a dose of material derived at least partially from natural fibres, having a forming region (2) delimited by a lateral surface (3) extending around a central zone of the forming region (2), the moulding apparatus (1) comprising:
a first half-mould (5) defining said forming region (2), comprising a transverse surface (4) and said lateral surface (3) defining a forming cavity;
a second half-mould (6), the first half-mould (5) and the second half-mould (6) being mutually movable along a moulding axis (Y) so that the second half-mould (6) is inserted into said forming cavity for shaping said dose; and
a cutting device (16) adapted to abut against said first half-mould (5) for cutting a scrap of said object exiting from said forming chamber.
